(19) United States
(12) Patent Application Publication
(10) Pub. No.: US 2019/0156657 A1
(43) Pub. Date: May 23, 2019

(54) METHOD FOR THE REMOTE MONITORING OF PERSONS THROUGH SMART MOBILE TERMINALS AND WEB SERVICES

(71) Applicant: E.L. EASY LIFE UK LIMITED, London (GB)

(72) Inventors: Luca LA FERLA, Milano (MI) (IT); Luca CONCONE, London (GB)

(21) Appl. No.: 16/301,775

(22) PCT Filed: May 26, 2017
(86) PCT No.: PCT/IB2017/053114

§ 371 Date: Nov. 15, 2018

(30) Foreign Application Priority Data
May 27, 2016 (IT) 102016000054850

(51) Int. Cl. G08B 25/01; G08B 21/18; G08B 25/00

(52) U.S. Cl. CPC G08B 25/016; G08B 21/18; G08B 21/0222; G08B 25/006; G08B 25/009

(57) ABSTRACT

A method for the remote monitoring of a person by another person through smart mobile terminals (A, D) connected to the web via a data network (B) and provided with a geo-localization device, a gyroscope and a dedicated application includes the installation on a cloud infrastructure of an articulated set (C) of web services and backend applications connected via the data network (B) to the applications installed on the terminals (A, D) so as to act as an interface between them, and the triggering of an alarm procedure by the application of the person to be monitored upon occurrence of one or more alarm conditions provided in a configuration present on the relevant terminal (D), the activation and configuration of the application installed on the terminal (D) of the person to be monitored being carried out by the application installed on the terminal (A) of the monitoring person, by sending the configuration to the articulated set (C) via the data network (B) for storage and subsequent sending of the configuration, again via the data network (B), to the terminal (D) of the person to be monitored.

The present invention relates to methods for the remote monitoring of persons such as the elderly, the sick, minors and women, and in particular a system that exploits the technical capabilities of the now ubiquitous smart mobile terminals equipped with GPS (smartphones, tablets and the like) and their constant connection to the web via data connections (GPRS, GSM, 3G, 4G, WI-FI). In the following, reference will be made to the most common case of smartphones with 3G connectivity, but it is clear that what is said applies to any combination of terminals and connections of the various types possible. It is also clear that a smart terminal could also be integrated into a mobile object (e.g. a car) or assigned to an animal (e.g. in a dog collar), so what is being said also applies to the monitoring of objects and animals.

It is known that smartphones are equipped with sensors such as accelerometers and gyroscopes through which they can detect their motion in three-dimensional space, these sensors being possibly used also to detect horizontal and vertical speed, and by integrating this information with data from GPS and AGPS (Assisted GPS) services it is possible to geo-localize a person's position. Moreover, smartphones obviously make it possible to make an audio/video connection with another terminal, mobile or not, to provide live broadcasts of what's going on around.

However, these technical capabilities are not used automatically to increase the security of the person who owns the smartphone, since in the event of an emergency it is the person him/herself who must actively activate the smartphone to seek help, typically by calling the emergency services or by using a dedicated application (for example by shaking the smartphone). However, this is often not possible because the person may be incapacitated to act for various reasons, being unconscious, injured, shocked or the like.

Likewise, the smartphone could provide information about the position and speed of a person if its sensor data were appropriately processed and sent to a monitoring center.

US 2015/0213700 describes a personal emergency notification system involving a wearable signaling device that is radio-connected (Bluetooth or similar) to the user's smartphone that has a dedicated application (so-called app) that in response to an alarm signal coming from the signaling device activated by the user, for example by simultaneously pressing two buttons, sends a request for help to a web service that forwards this request to public emergency services and/or to a “network of guardians” consisting of relatives, friends or trusted people who have a similar app on their smartphone, this web service also coordinating the responses and communications between the alerted individuals.

Such a system certainly enhances the user's safety, which in order to notify the emergency does not necessarily have to have access to the smartphone but only to the wearable signaling device that can take various forms to be always at hand (e.g. bracelet, button, pendant, belt, etc.). However, also this system has limitations and drawbacks, especially if the user is a “weak” subject such as an elder or a child and/or a subject with poor ability to manage the app.

In fact, in the case of “weak” subjects, the above-mentioned system has the limit of not being able to prevent possible emergency situations but only to report them, whereas it would be useful to be able to remotely monitor those subjects to check that they do not get into situations of potential danger or even just that they are in a state of well-being.

Moreover since the effectiveness of the system depends on the configuration enabled and set on the user's smartphone if such configuration is unintentionally disabled or altered, due to inexperience or distraction, without the user being aware of that, as a result the system may be unavailable in case of necessity.

The object of the present invention is to provide a remote monitoring method that can maximize the exploitation of the above-mentioned technical capabilities of a smartphone to increase the safety of its owner, ensuring the system's constant availability and a high efficacy even in a preventive function. This object is achieved by means of a method in which a terminal of a person to be monitored (so-called Agent), preferably radio-connected (Bluetooth or similar) to an alarm button equipped with a triaxial accelerometer, and a terminal of a person who manages the monitoring (so-called Master) are both provided with a dedicated app that connects them via a data network to an articulated set of web services and backend applications that acts as an interface between them, the Agent terminal configuration being enabled and configured by the app installed on the Master terminal by sending said configuration to said articulated set for storage and subsequent sending thereof to the Agent terminal, which in turn sends to the Master terminal, again via the data network and the articulated set, a set of information which it has collected, such submission being made at pre-set intervals and/or at the request of the Master terminal.

An important first advantage of this method is to allow an effective monitoring of the Agent by the Master as a function of prevention of potential dangerous situations, thanks to the “asymmetric” operation that allows the Master to control the configuration parameters of the Agent terminal and to be alerted when this configuration is disabled. Furthermore, in this way even users incapable of managing the app cannot involuntarily affect the effectiveness of the system, which will always be available when needed.

A second significant advantage of this method is to allow an automatic alarm to be sent upon occurrence of a series of specific situations, even of not real emergency, set up by the Master and detected by the Agent's sensors, such as:
the vertical speed that can be used to define the fall alarm and indicate the possibility that the person has fallen such as, for example, an elder that slipped at home (free fall detection);
the horizontal speed that can be used to determine a threshold beyond which the system signals an excessive speed alarm such as, for example, a minor traveling at over 60 km/h which implies that it is on a means of transport and this can be reported as inadequate;
the geo-localization that can be used to verify that the person is in a safe area or vice versa that he/she is not in a dangerous area (so-called geo-fencing), and otherwise notify the emergency contacts possibly transmitting the audio and (optionally) the video from the Agent terminal to have also a context picture of what's happening;
the geo-localization that can also be used to verify whether a person has reached/left a given place within a predetermined time, and if the condition does not occur within the expected time an alarm procedure for no arriving/leaving is activated;
a management system of the personal contacts to be notified in case of emergency (ICE—In Case of Emergency);
a pre-configured system of contact groups that are constituted by a social network of individuals offering their availability to intervene (safety net);
a proximity calculation system to send the emergency notification to the contacts closest to the Agent terminal requesting help.

Another advantage of this method is to accomplish the above functions without requiring additional components except, in the preferred embodiment, the above-mentioned alarm button which improves the fall alarm function and may also be useful as an emergency switch as further described below.

Further advantages of the present method can be summarized as follows:

independence from software/hardware platforms;
portability to other devices, terminals and sensors;
customization of audio messages for greater incisiveness and effectiveness;
scalability, thanks to the cloud-based web service solution;
extensibility, not just to smartphones but to all smart devices in general (Internet of Things) whereby the Agent terminal can be an apparatus that is simpler and cheaper than a smartphone, which is especially preferable for elderly or children users;
cost-effectiveness, since the service has a very limited cost.

These and other advantages and features of the method according to the invention will be apparent to those skilled in the art from the following detailed description with reference to the accompanying drawings in which:

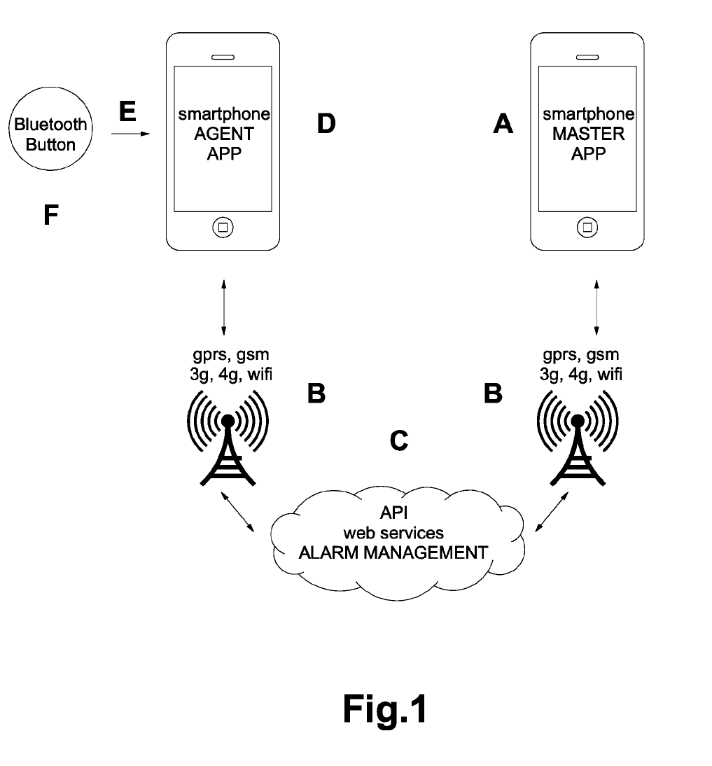

FIG. 1 is a general structural scheme of the system that implements this method;

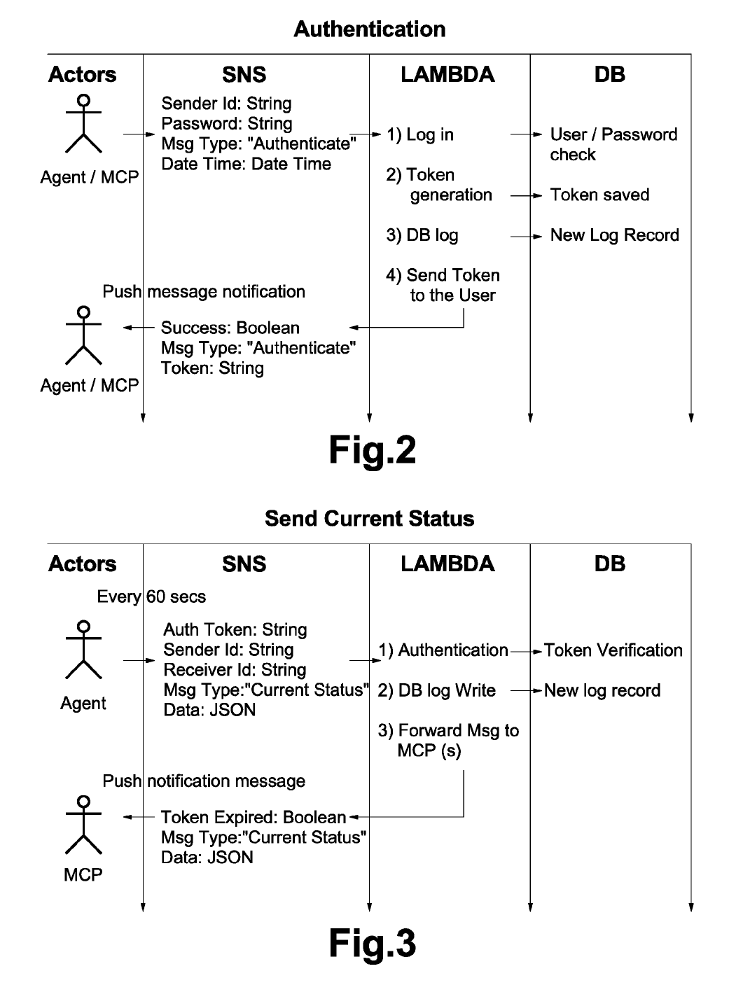

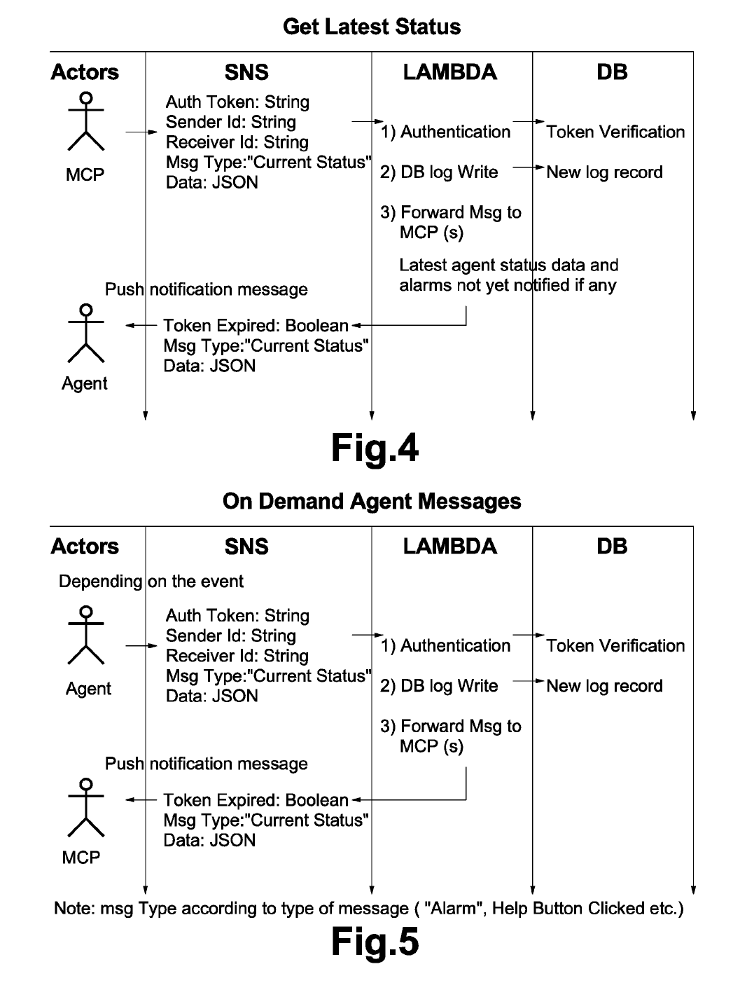

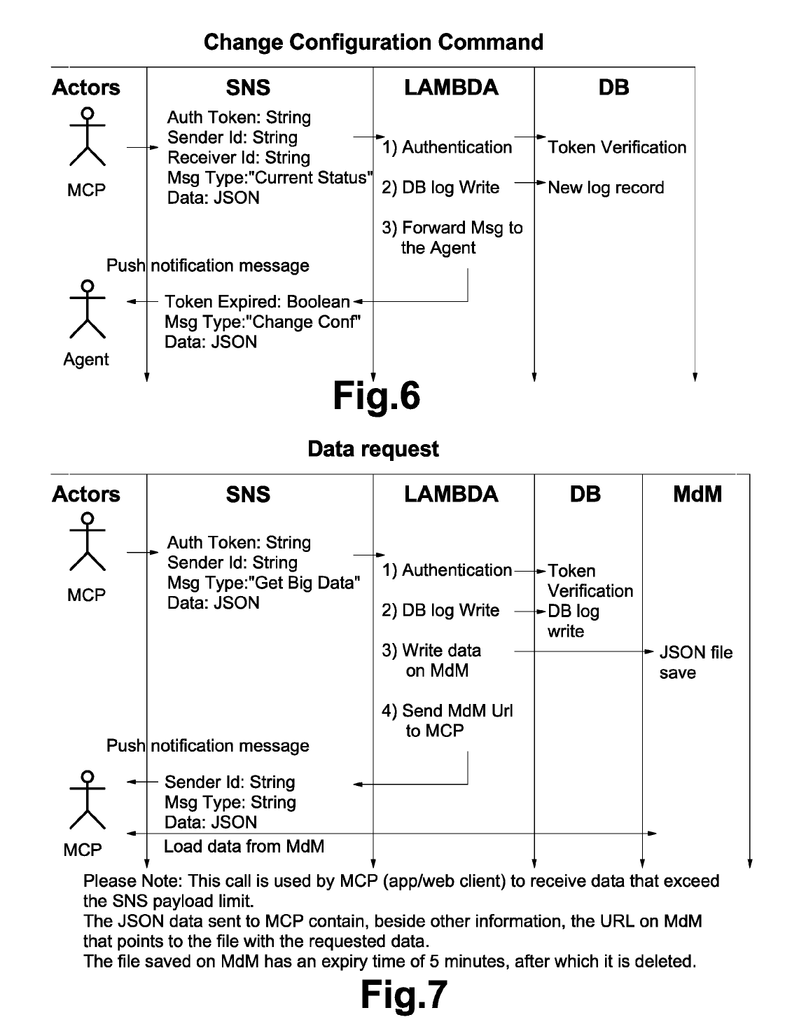

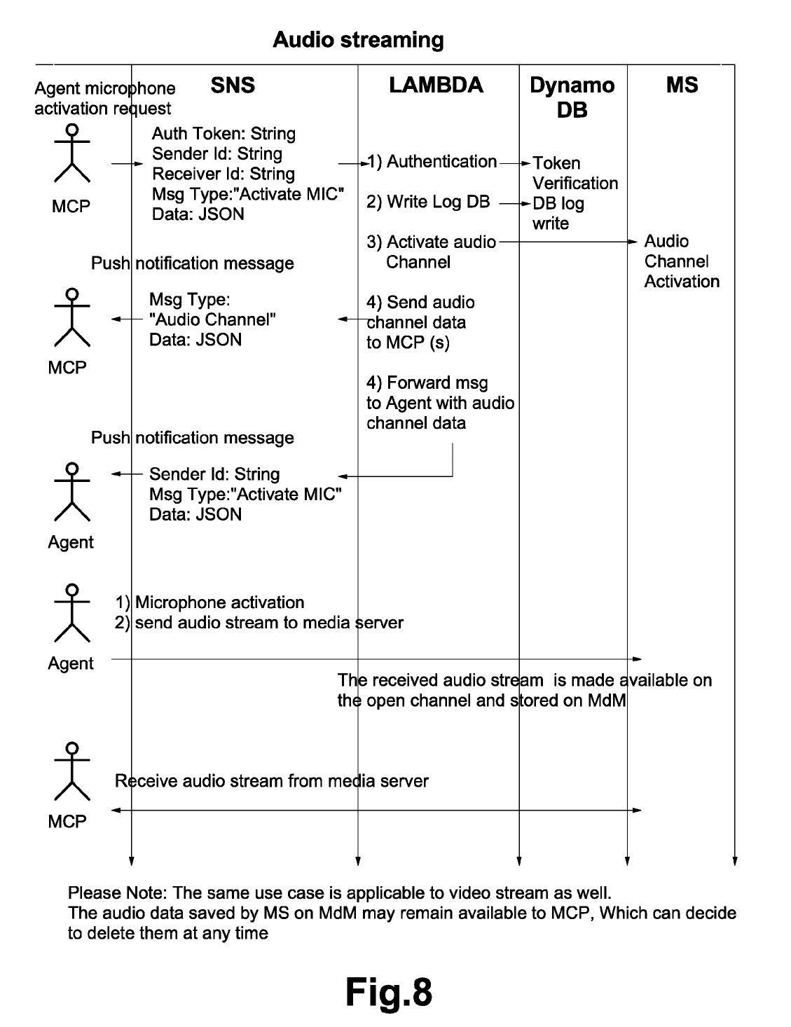

FIGS. 2 to 8 are diagrams of cases of system usage;

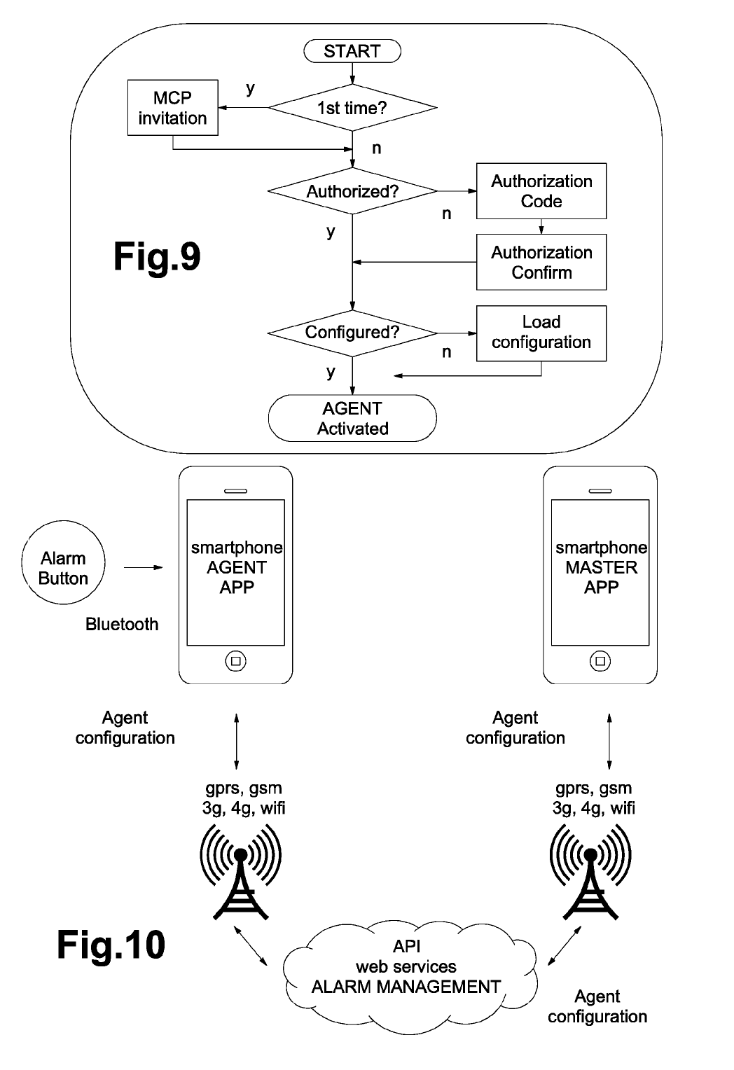

FIG. 9 is a flow chart of the Master and Agent app configuration process;

FIG. 10 is a system operating scheme in the Master and Agent app configuration process; and

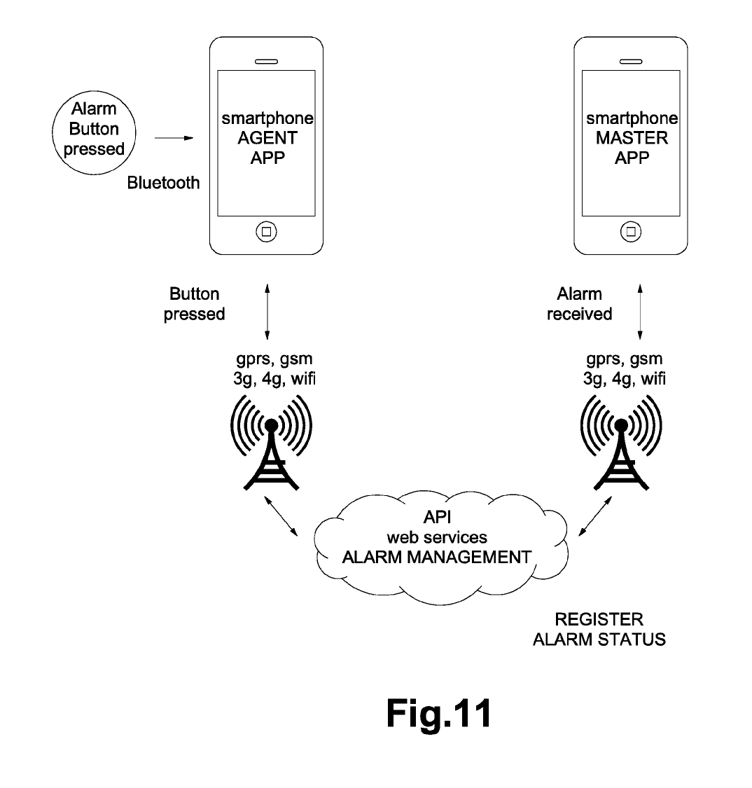

FIG. 11 is a system operation scheme in the case of activation of an alarm condition.

Referring to FIG. 1, there is seen that the system implementing the method according to the present invention is articulated on different planes and uses sensors in an asymmetric Master/Agent architecture, where a Master terminal A is connected via a data network B to a set C residing on a cloud computing infrastructure that connects it, again via data network B, to an Agent terminal D that is preferably associated via a short-range radio link E (typically Bluetooth) to an alarm button F equipped with a triaxial accelerometer.

The Master terminal A has a function of control over the Agent terminal D that has sensors (in the smartphone and in the Bluetooth button F) which collect the data that terminal D sends to preconfigured network services (web services WS) which process and analyze them to verify that these data are within the threshold established when the Agent terminal D is configured by the Master terminal A.

In particular, this system consists of:

a set of apps for major operating systems for smartphones loaded on terminals A, D with mobile networking connection services, WI-FI, Bluetooth 4.0 LE or above, enabled and working GPS (apps may be installed on devices with different operating systems);
an articulated set C of web services (WS) and backend applications installed on a cloud infrastructure;
a Bluetooth 4.0 LE or higher/iBeacon hardware with triaxial accelerometer (optional alarm button F) that works in conjunction with the apps and Agent terminals D on which they are installed.

The app installed on the Master terminal (smartphone) A is the activation and configuration tool of the app installed on the terminal (smartphone) D of the person to be monitored, i.e. the Agent. From the Master terminal A you can configure and manage:

the Agent's phone book and/or appointment book;
the alarm and notification levels and modes;
the audio messages recorded by the Master to be associated with events in the Agent's appointment book;
the definition of an area within which the Agent can be defined as safe or unsafe (so-called geo-fencing);
the definition of geo-localized locations with controls on arrival and departure (check-in and check-out);
the definition of the maximum travel time to reach a destination;
the calibration of the sensitivity of motion sensors (horizontal and vertical speeds);
the configuration, activation and deactivation of the alarm button F possibly associated with the Agent terminal D.

The data networks B are those that allow terminals A and D to communicate with set C of web services developed and activated for this purpose and, as already mentioned, terminals A and D can use any communication protocol made available by their respective providers of connectivity (currently GPRS, GSM, 3G, 4G and WI-FI). The heart of the system and where its “intelligence” resides consists in an architecture installed on a cloud infrastructure both in public and in private or hybrid configuration where a set C of functions/services are active and perform predetermined operations based on environmental variables and data received from the apps installed on terminals A and D. This set C of functions are available as web services through specific application interfaces (API=Application Program Interface).

In general, the apps of terminals A and D do not communicate directly between them but through a standard interface that activates these functions, the most common use cases being illustrated in FIGS. 2 to 8 which are self-explanatory and include acronyms having the following definitions:

MCP—Master Control Program, is the main app management program;
SNS—Simple Notification Service, is a communication interface between the various application components;
FCA—Features of Cloud Application, represents application features installed and configured as web services WS within the cloud infrastructure;
DB—Database, represents the system database;
JSON—JavaScript Object Notation, indicates the type of data being transmitted
MdM—are mass memories where large system messages (audio/video) are recorded;
MS—Media Server, is the system for managing multimedia streams.

The Agent terminal D is the sensor for the person to be monitored that communicates with set C on the cloud infrastructure, the minimum requirements of Agent terminal D being:

data connection (GPRS, GSM, 3G, 4G and WI-FI)

### GPS/AGPS

Bluetooth LE 4.0 or higher
triaxial accelerometer
gyroscope

As already mentioned, the Agent app is configured and activated by the Master app and has a simplified interface to facilitate the adoption of terminal D by the person being protected. The alarm button F is connected via connection E to this terminal D, and terminal D collects and sends all the relevant information for control and safety to set C.

Specifically, at pre-set intervals or at the request of the Master app, the Agent app sends to the web services WS a collection of information gathered from terminal D and from button F:

last geo-localized position;
last detection of horizontal and vertical speed;
battery status of terminal D and possible alarm button F;

general state of the subsystem (operational, yellow alarm, red alarm);

detection timestamp.

As mentioned above, the presence of the alarm button F is not strictly indispensable but is definitely preferable to improve and expand the monitoring service functions. In fact, the alarm button F is intended to be worn by the monitored user (e.g. at the belt or on the chest) and allows to avoid false alarms and/or to report a dangerous situation more easily and discreetly. For example, if terminal D is dropped by the Agent this could be interpreted as a fall of the Agent resulting in a false alarm, but if the accelerometer of button F does not indicate the same situation such a false alarm can be avoided. Conversely, the Agent may fall at home at a time when terminal D is resting on a support and therefore does not detect the acceleration that however is detected by button F worn by the user thus triggering the alarm.

Similarly, if the Agent is in dangerous situation in which he/she cannot access terminal D (e.g. a robber who grabs a woman's purse containing her smartphone), it is still possible for the Agent to trigger the alarm through button F. The main functions of the alarm button F are therefore the following:

the fall alarm procedure, which is activated if terminal D receives via connection E the signal that the accelerometer of button F has suddenly undergone a strong acceleration [>2,5 g] with high angular velocity [θ>65°/s] (free fall detection), which is interpreted as a hypothesis that the Agent may have fallen or is in a state of danger;
the help request alarm procedure, that is activated if terminal D receives via connection E the indication that button F has been pressed for a prolonged time, for example with a threshold that can be set between 2 and 8 seconds, and also in this case it can be assumed that the Agent is in a state of danger.

In addition to these main functions other system functions/services related to button F are provided as optional, such as:

automatic pairing of button F for initial association with terminal D;
reading of battery status;
turning on a LED and/or a buzzer of button F when searching for the button;
automatic connection in the event of a temporary interruption of communications, if button F goes out of the Bluetooth connection range and then returns within connection radius;
Agent activity detection (e.g. pedometer)
outdoor temperature detection;
audio-localization of the smartphone by having it ring by pressing button F.

By way of non-limiting example, the preferred technical features of button F are as follows:

Operating mode: Bluetooth Low Energy (BLE)
Frequency range: 2402-2480 MHz (40 channels with 2 MHz separation)
Data transmission rate: 1 Mbps

### Modulation: GFSK

Antenna type/gain: PIFA, 0,21 dBi
Power supply: 3V DC (battery included with guaranteed 1 year life)
Range: 25 m in interior/100 m in exterior
Rugged plastic housing

### Weight: ≤12 g

### Waterproof: IP 67

Triaxial accelerometer

### LED/loudspeaker

Software development platform (js, java, c, c #)
iBeacon compatibility
Temperature sensor

Before being active, the Agent and Master app system must be configured as in the flow diagram of FIG. 9 and scheme of FIG. 10. The configuration covers various settings such as:

a geo-localized area within which the Agent is free to operate or vice versa must not operate;
a series of places;
a list of personal contacts and contacts to be notified in case of emergency (ICE—In Case of Emergency);
a list of groups of “social” contacts that can intervene when needed (safety net);
a list of events (appointment book) to which a customized audio message can be associated;
an operating mode of the Agent terminal interface.

At the end of the configuration phase that is performed on terminal A where the Master app is installed, the configuration is sent to the web services WS on the cloud infrastructure where set C resides, via the data network B, for storage and subsequent sending, again via the data network B, to the Agent app on terminal D. Once the configuration is received, the Agent terminal D is configured according to the instructions contained therein.

For the Agent monitoring function, at pre-set intervals, the Agent app sends to set C information about various terminal D parameters such as the status and location of the terminal, the battery level of the terminal and alarm button F, and other useful information. This information is temporarily recorded on mass memories and made available on request to the Master app that displays them on terminal A.

As mentioned earlier, the triggering of alarm procedures can take place for various reasons, such as:

a prolonged pressure on the alarm button F or on a virtual button on the user interface on terminal D;
detection of the fall condition from the reading of the accelerometer of terminal D and/or alarm button F;
an excursion of terminal D, detected by geo-localization services managed by the Agent app, outside of the safe area or inside of the dangerous area defined in the configuration;
a battery level of terminal D and/or button F below a pre-set threshold.

Alarms sent from the Agent app on terminal D are handled by web services WS and backend applications of set C that perform a number of scheduled operations according to pre-set configurations. Alarms are divided into two main categories:

weak (yellow) alarm that does not require immediate attention but detects a state of necessity by the Agent and is notified with a push message only to the Master app on terminal A via the data network B; and
strong (red) alarm that involves an emergency situation triggered by the Agent that requires immediate intervention and therefore in this case the notification is performed to the numbers defined in the configuration by means of:
SMS with the latest geographic coordinates of Agent terminal D and alarm time (via normal mobile network);
voice calls with pre-recorded messages (via the normal mobile network);
push notification on Master terminal A via data network B.

In light of the above, it is clear that compared to the known systems and the simple apps currently available on the market, this solution is a major improvement covering the various aspects of the Agent's control, safety and well-being through a more sophisticated architecture with splitting of the Master/Agent functionalities and intelligence not in the apps installed on the terminals but in the backend on the cloud infrastructure.

The monitoring method according to the present invention can thus be summarized in the following steps:

a) installation on a cloud infrastructure of an articulated set C of web services and backend applications connected, via a data network B, to corresponding applications installed respectively on the A and D terminals of the Master and Agent subjects;
b) activation and configuration of the application installed on the Agent terminal D by the application installed on the Master terminal A by sending the configuration to said set C via the data network B, for storage and subsequent sending of said configuration, again via said data network B, to the Agent terminal D;
c) sending to the Master terminal A, via the data network B and set C, by the Agent application of a set of information collected by terminal D, said sending being carried out at pre-set intervals and/or at the request by the Master application;
d) triggering of an alarm procedure by the Agent application upon occurrence of one or more alarm conditions provided in the configuration present on terminal D, through sending of an alarm to set C that depending on said alarm performs a series of programmed operations among which at least a notification to the Masters application on terminal A.

1. Method for the remote monitoring of a person by another person through smart mobile terminals (A, D) connected via a data network (B) and provided with a geo-localization device, a gyroscope/accelerometer and a dedicated application, said method including the steps of:
a) installation on a cloud infrastructure of an articulated set (C) of web services and backend applications connected via said data network (B) to said applications installed on the terminal (A) of the monitoring person and on the terminal (D) of the person to be monitored, said articulated set (C) being able to carry out predefined operations on the basis of environmental variables and of data received from the applications installed on the terminals (A, D) so as to act as an interface between them;
b) triggering of an alarm procedure by the application of the person to be monitored upon occurrence of one or more alarm conditions provided in a configuration present on the relevant terminal (D), through sending of an alarm to said articulated set (C) that depending on said alarm performs a series of programmed operations among which at least a notification to the application of the monitoring person on the relevant terminal (A);
wherein the method further including the steps of:
a′) activation and configuration of the application installed on the terminal (D) of the person to be monitored by the application installed on the terminal (A) of the monitoring person, by sending said configuration from the latter terminal (A) to said articulated set (C) via the data network (B) for storage and subsequent sending of the configuration, again via the data network (B), to the terminal (D) of the person to be monitored; and
a″) sending to the terminal (A) of the monitoring person, via the data network (B) and said articulated set (C), by the application of the person to be monitored of a set of information collected by the relevant terminal (D), said sending being carried out at pre-set intervals and/or at the request by the application of the monitoring person.

2. Method according to claim 1, in which in step a′) one or more of the following features/functions of the terminal (D) of the person to be monitored are configured:
the phone book and/or the appointment book;
the alarm and notification levels and modes;
the audio messages to be associated to events;
the definition of an area inside which the person to be monitored can be defined safe or unsafe;
the definition of geo-located places with control functions on arrival and departure;
the definition of the maximum travel time to reach a destination;
the calibration of the sensitivity of the movement sensors;
the definition and configuration of the contacts to be notified in case of emergency;
the selection of groups of pre-configured contacts that can intervene in case of need; and
the configuration, activation and deactivation of an alarm button (F), if any, provided with a triaxial accelerometer and a short-range radio link (E) to the terminal (D) of the person to be monitored.

3. Method according to claim 1, in which in step a″) one or more of the following information are sent to the terminal (A) of the monitoring person:
latest geo-located position;
latest detection of the horizontal and vertical speed;
battery status of the terminal (D) of the person to be monitored and of the alarm button (F), if any, associated therewith; and
general status and timestamp of detection.

4. Method according to claim 1, in which in step b) the alarm procedure is triggered upon occurrence of one or more of the following conditions:
a prolonged pressure of a virtual button present on the user interface on the terminal (D) or of the alarm button (F) if it is provided with a pressure sensor operatively connected to the terminal (D) to trigger the sending of a request for help when said pressure sensor is activated for a prolonged period of some seconds;
the detection of a free fall state from the reading of the accelerometer of the terminal (D) and/or of the alarm button (F);
an excursion of the terminal (D) of the person to be monitored outside of a safe area or inside of an unsafe area defined upon configuration; and
a battery level of the terminal (D) and/or of the alarm button (F) below a pre-set threshold.)

5. Method according to claim 4, in which in the condition of low battery level a weak alarm is sent through a push message only to the application on the terminal (A) of the monitoring person, whereas in the other cases a strong alarm is sent that in addition to said push message also includes the notification to the numbers defined upon configuration through a text message with the latest geographical coordinates of the terminal (D) of the person to be monitored and the time of alarm, as well as voice calls with pre-recorded messages and possibly the activation of the microphone and/or the camera of the terminal (D).

6. Method according to claim 2, in which in step a″) one or more of the following information are sent to the terminal (A) of the monitoring person:
latest geo-located position;
latest detection of the horizontal and vertical speed;
battery status of the terminal (D) of the person to be monitored and of the alarm button (F), if any, associated therewith; and
general status and timestamp of detection.

7. Method according to claim 2, in which in step b) the alarm procedure is triggered upon occurrence of one or more of the following conditions:
a prolonged pressure of a virtual button present on the user interface on the terminal (D) or of the alarm button (F) if it is provided with a pressure sensor operatively connected to the terminal (D) to trigger the sending of a request for help when said pressure sensor is activated for a prolonged period of some seconds;
the detection of a free fall state from the reading of the accelerometer of the terminal (D) and/or of the alarm button (F);
an excursion of the terminal (D) of the person to be monitored outside of a safe area or inside of an unsafe area defined upon configuration; and
a battery level of the terminal (D) and/or of the alarm button (F) below a pre-set threshold.

8. Method according to claim 3, in which in step b) the alarm procedure is triggered upon occurrence of one or more of the following conditions:
a prolonged pressure of a virtual button present on the user interface on the terminal (D) or of the alarm button (F) if it is provided with a pressure sensor operatively connected to the terminal (D) to trigger the sending of a request for help when said pressure sensor is activated for a prolonged period of some seconds;
the detection of a free fall state from the reading of the accelerometer of the terminal (D) and/or of the alarm button (F);
an excursion of the terminal (D) of the person to be monitored outside of a safe area or inside of an unsafe area defined upon configuration;
a battery level of the terminal (D) and/or of the alarm button (F) below a pre-set threshold.

9. Method according to claim 7, in which in the condition of low battery level a weak alarm is sent through a push message only to the application on the terminal (A) of the monitoring person, whereas in the other cases a strong alarm is sent that in addition to said push message also includes the notification to the numbers defined upon configuration through a text message with the latest geographical coordinates of the terminal (D) of the person to be monitored and the time of alarm, as well as voice calls with pre-recorded messages and possibly the activation of the microphone and/or the camera of the terminal (D).

10. Method according to claim 8, in which in the condition of low battery level a weak alarm is sent through a push message only to the application on the terminal (A) of the monitoring person, whereas in the other cases a strong alarm is sent that in addition to said push message also includes the notification to the numbers defined upon configuration through a text message with the latest geographical coordinates of the terminal (D) of the person to be monitored and the time of alarm, as well as voice calls with pre-recorded messages and possibly the activation of the microphone and/or the camera of the terminal (D).
